(19) United States
(12) Patent Application Publication
(10) Pub. No.: US 2011/0206055 A1
(43) Pub. Date: Aug. 25, 2011

(54) METHOD AND PACKET SWITCH APPLIANCE FOR PERFORMING PACKET DEDUPLICATION

(76) Inventor: Patrick Pak Tak Leong, Palo Alto, CA (US)

(21) Appl. No.: 12/712,093

(22) Filed: Feb. 24, 2010

(51) Int. Cl. H04L 12/56

(52) U.S. Cl. 370/401

(57) ABSTRACT

A packet switch appliance and method for performing packet deduplication are described. In one embodiment, the packet switch appliance comprises a first network switch chip to receive packets from the network and a processor coupled to the first network switch chip and operable to perform a method comprising receiving the packets, identifying a packet as a duplicate packet if at least a portion of the packet is identical to a corresponding portion of another packet received within a predetermined period of time, and discarding the packet if the packet is the duplicate packet.

### FIELD OF THE INVENTION

The present application relates generally to network switches and, more specifically, to a packet switching appliance that removes duplicate packets from a stream of packets.

### BACKGROUND

In a packet-switching network, the transmission, routing, forwarding, and the like of messages between the terminals in the packet-switching network are broken into one or more packets. Typically, data packets transmitted or routed through the packet switching network comprise three elements: a header, a payload, and a trailer. The header may comprise several identifiers such as source and destination terminal addresses, VLAN tag, packet size, packet protocol, and the like. The payload is the core data for delivery, other than header or trailer, which is being transmitted. The trailer typically identifies the end of the packet and may comprise error checking information (e.g., CRC information). Data packets may conform to a number of packet formats such as IEEE 802.1D or 802.3.

Associated with each terminal in the packet-switching network is a unique terminal address. Each of the packets of a message has a source terminal address, a destination terminal address, and a payload, which contains at least a portion of the message. The source terminal address is the terminal address of the source terminal of the packet. The destination terminal address is the terminal address of the destination terminal of the packet. Further, each of the packets of a message may take different paths to the destination terminal, depending on the availability of communication channels, and may arrive at different times. The complete message is reassembled from the packets of the message at the destination terminal. One skilled in the art commonly refers to the source terminal address and the destination terminal address as the source address and the destination address, respectively.

Packet switch appliances can be used to forward a copy of packets (either obtained through a SPAN port of a switch or router, or by making a copy of each packet through its built-in tap modules) in the packet-switching network, to network monitoring or security tools for analysis thereby. Typically, such packet switch appliances have one or more network ports for connection to the packet-switching network and one or more instrument ports connected to one or more network instruments, typically used to monitor packet traffic, such as packet sniffers, intrusion detection systems, application monitors, or forensic recorders.

The packet switching demands of networks may vary greatly depending on the size and complexity of the network and the amount of packet traffic. Users may also desire expanded packet handling and processing functionality of the packet switch appliances beyond basic switching, routing, and filtering.

Users may also wish to deploy various network instruments for monitoring packet traffic. In order to monitor every packet that goes through a switch, a span port is usually set up such that a copy of every packet is made when they pass through the ports, ingress or egress. Therefore, for a packet that enters in one port of the switch and then egresses out of another port of the same switch, at least two copies of this packet are sent out of the span port. If this packet is a multicast packet, then the switch will send out multiple copies of this packet through multiple ports, and hence the span port will send out even more copies of this packet. In this kind of situation, the copies of the packet coming out of the span port are usually identical.

In other situations, the switch may change the VLAN tag of the packet such that within the copies of this packet, some of them may have different VLAN tags. Also, the packet may go through a router, in which case the destination MAC address or even the IP header information may have been changed but the payload remains the same.

If copies of packets are made at other network devices and forwarded to the same analysis tool, the analysis tool may be receiving packets with the same payload at slightly different times. The generation of duplicate packets can also occur in redundant network segments depending on the location of tapping points within the segments that are used to tap packets to be forwarded to an analysis tool. That is, depending on where taps are located in a redundant network segment, multiple copies of the same packet or multiple copies of packets with the same payload (i.e., packets that only have different destination and/or source addresses) may be generated. The presence of such duplicate packets can prevent accurate analysis from occurring, can negatively influence available bandwidth in the network, or can overwhelm a tool that does not have the performance to handle all these packets which carry duplicated information. Therefore, it is desirable to remove duplicate packets prior to any analysis or monitoring.

### SUMMARY OF THE INVENTION

A packet switch appliance and method for performing packet deduplication are described. In one embodiment, the packet switch appliance comprises a first network switch chip to receive packets from the network and a processor coupled to the first network switch chip and operable to perform a method comprising receiving the packets, identifying a packet as a duplicate packet if at least a portion of the packet is identical to a corresponding portion of another packet received within a predetermined period of time, and discarding the packet if the packet is the duplicate packet.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates an exemplary packet switching network and a packet switch appliance;

FIG. 2 illustrates an exemplary mother board and daughter board having a processor unit of a packet switch appliance;

FIG. 3 illustrates an exemplary packet handling process in an exemplary packet switch appliance with a daughter board having a processor unit; and

FIG. 4 is a flow diagram of one embodiment of a process for performing packet deduplication with a packet switch appliance.

### DETAILED DESCRIPTION OF THE PRESENT INVENTION

A method and a packet switch appliance for performing duplicate packet removal (i.e., packet deduplication) are described. In one embodiment, the packet switch appliance monitors packets and can declare that two or more of the packets are duplicates. In one embodiment, this determination is based on direct or indirect analysis of a portion of the packets, such as their payloads or an entire packet. Once the packet switch appliance declares that a particular packet is a duplicate, the packet may be dropped. Such processing may help reduce the number of packets seen by or forwarded to a monitoring or analysis tool in the network.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

### Overview

A packet switch appliance in a packet switching network monitors packets to identify duplicate packets and causes the packets identified as duplicates to be dropped or removed from a packet flow.

In one embodiment, the duplicate packet removal process compares a portion of each packet that has been received with other packets that have been received within a time window (i.e., a predetermined period of time). In another embodiment, the whole packet is compared. The packets may be received from a span port of a switch in the packet switching network. In one embodiment, the comparison is performed on the CRC portions of packets (or whole packets) received within the time window. In another embodiment, the comparison is based on function (e.g., hash) values generated by applying a function (e.g., a hash function) to the same portions of packets. If the result of a comparison is a match, the packet switch appliance declares the packets as duplicates and discards one of the duplicated packets. The discarded packet is typically the packet that was most recently received. Those packets that are not discarded are forwarded on into the network or to another network device, such as, for example, a packet analysis tool. In one embodiment, the packet switch appliance computes a hash value on every packet based on certain offsets (e.g., the number of bytes counted from the beginning of a packet) that the user wants to start the comparison. The first packet with a new hash value is forwarded by the packet switch appliance. Any subsequent packets within a time window that has the same hash value is discarded.

In one embodiment, the packet removal process is performed by a multi-core processor. Alternatively, the packet removal process is performed by either a network processor unit (NPU), an application specific integrated circuit (ASIC), or a field programmable logic gate array (FPGA).

An example of a packet switch appliance configured to perform the duplicate packet removal (i.e., deduplication) process as well as an example of a network configuration in which the packet switch appliance resides are described below.

### An Example of a Network Configuration

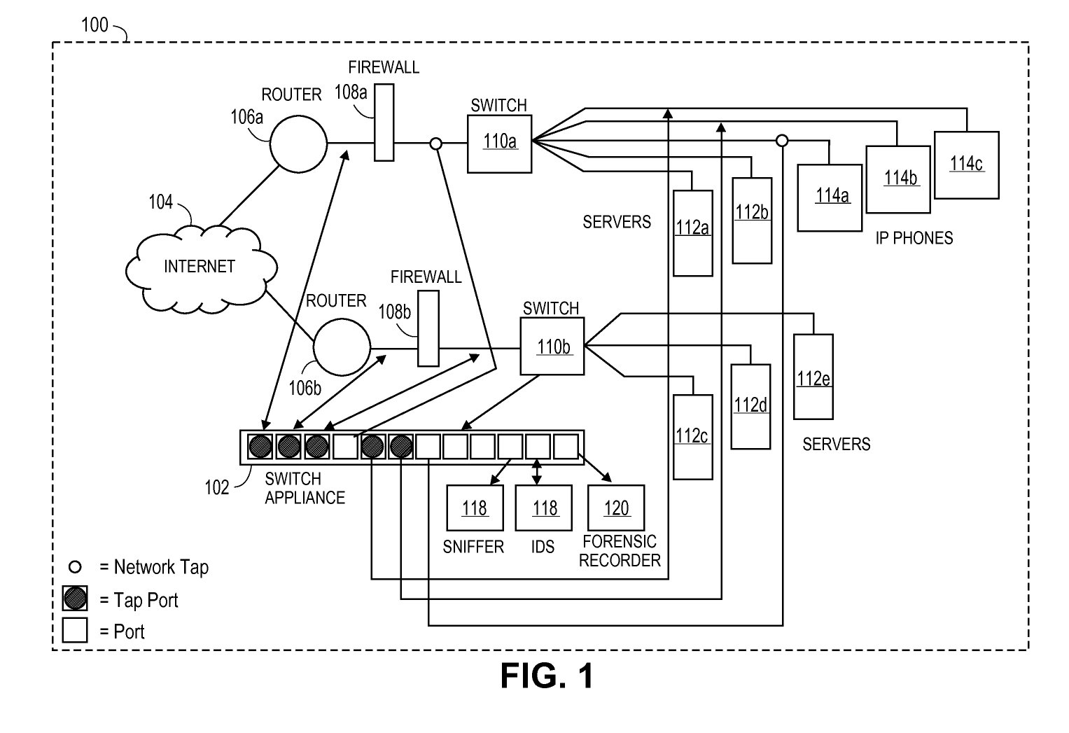

With reference to FIG. 1, in one exemplary embodiment, a packet switch appliance 102 is integrated into a packet switching network 100. The interne 104 is connected via routers 106a and 106b and firewalls 108a and 108b to switches 110a and 110b. Switch 110a is also connected to servers 112a and 112b and to IP phones 114a-c. Switch 102b is also connected to servers 112c-e. Packet switch appliance 102 is connected to various points of the network via network taps and tap ports on the packet switch appliance. Packet switch appliance 102 is also connected to a variety of network instruments for monitoring network-wide packet traffic: packet sniffer 116, intrusion detection system 118, and forensic recorder 120. In alternate embodiments, a packet switching network may comprise fewer components or more components, than those depicted, and the connection of the packet switch appliance to the network may be varied.

In the embodiment of FIG. 1, because packet switch appliance 102 is connected to every device in the packet-switching network, the packet switch appliance has a global network footprint and may potential access all data packets transmitted across the network. Consequently, network instruments, e.g., packet sniffer 116, intrusion detection system 118, and forensic recorder 120, which are connected to packet switch appliance 102, can potentially access information anywhere throughout the packet-switching network.

A user of network 100, such as a network administrator, may wish to configure packet switch appliance 102 to perform a range of packet handling, distribution, or processing functionalities.

Packet switch appliance 102 may be configured to perform a number of packet distribution and handling functions such as one-to-one, one-to-many, many-to-one, and many-to-many port distributing, filtering, flow-based streaming, and load balancing. Such functions may be performed as described in U.S. Pat. Nos. 7,424,018, 7,436,832, and 7,440,467. Packet switch appliance 102 may also perform packet modifications functions such as packet slicing and packet regeneration based on header, payload, trailer, or other packet information.

Packet switch appliance 102 may also be configured to perform packet processing functions such as packet deduplication. Packet modification, packet copying, packet regeneration, and packet flow control are additional examples of packet processing.

Packet switch appliance 102 may find use as a network visibility system in conjunction with network instruments for packet traffic monitoring such as packet sniffers, intrusion detection systems, forensic recorders, and the like.

However, a given user may only require a subset of the potential functionalities of the packet switch appliance. Accordingly, it is beneficial and efficient for the packet switch appliance to be configured with scalable capacity and functionality ranging from basic packet handling and distribution to packet processing, including the packet deduplication described above.

### A Example of a Packet Switch Appliance

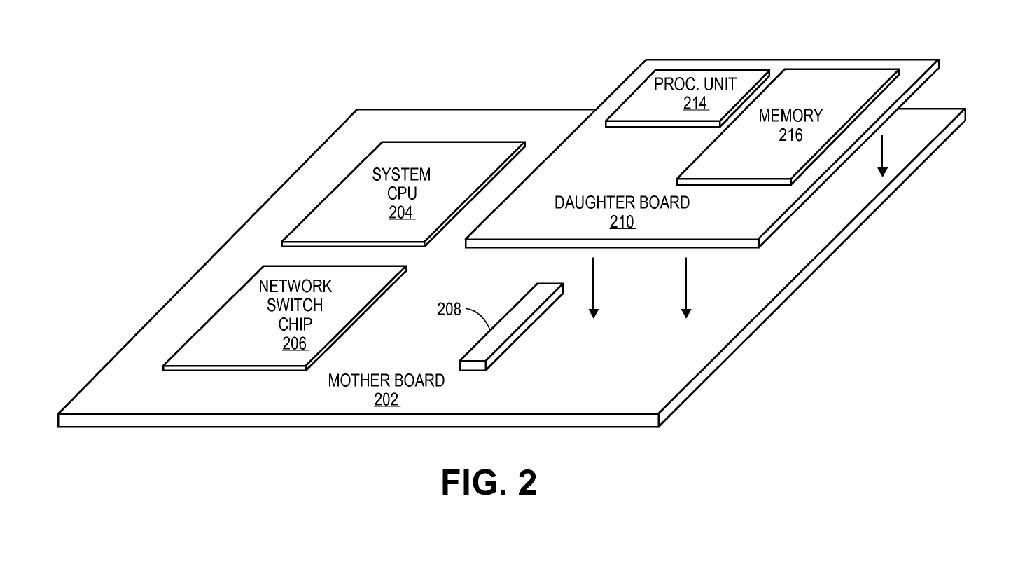

In embodiments depicted in FIGS. 2 and 5, packet switch appliance 102 may include a motherboard, which is the central or primary circuit board for the appliance. A number of system components may be found on motherboard 202. System CPU (central processing unit) 204 interprets programming instructions and processes data, among other functions. Network switch chip 206, also referred to as an “Ethernet switch chip” or a “switch on-a-chip”, provides packet switching and filtering capability in an integrated circuit chip or microchip design. Connector 208 provides motherboard 202 with the capacity to removably accept peripheral devices or additional boards or cards. In one embodiment, connector 208 allows a device, such as a daughter or expansion board, to directly connect to the circuitry of motherboard 202. Motherboard 202 may also comprise numerous other components such as, but not limited to, volatile and non-volatile computer readable storage media, display processors, and additional peripheral connectors. The packet switch appliance may also be configured with one or more hardware ports or connectors for connecting servers, terminals, IP phones, network instruments, or other devices to the packet switch appliance.

Network switch chip 206 is provided with a plurality of ports and may also be provided with one or more filters. The ports may each be half-duplex or full-duplex. Each of the ports may be configured, either separately or in combination, as a network port, an instrument port, a transport port, or a loop-back port. Network ports are configured for connection to and/or from the network. Instrument ports are configured for connection to and/or from a network instrument, such as a packet sniffer, intrusion detection system, or the like. Transport ports are configured for connection to and/or from another network switch chip, another switch appliance, or a processor unit, as described below.

The network switch appliance may include instructions stored on a computer readable medium for configuring single or dual port loop-back ports. The instructions may be executed on CPU 204. Each loop-back port reduces the number of ports available to be configured as a network, instrument, or transport port by at least one.

Each of the ports of network switch chip 206 may be associated with one or more packet filters that drop or forward a packet based on a criterion.

In an embodiment depicted in FIG. 2, daughter board 210 is configured to be removably connected to a motherboard 202, via connector 208. Daughter board 210 is a secondary circuit board of variable configuration. Daughter board 210 may be connected parallel to or in the same plane as the motherboard, as shown. In the parallel configuration, the daughter board may also be referred to as a mezzanine board. Alternatively, the daughter board may be oriented perpendicularly to the plane of the motherboard, or it may be connected in a differing orientation.

Daughter board 210 provides, in addition to packet distribution capabilities, packet processing capabilities. Daughter board 210 is configured with a processor unit 214 and memory 216. As with motherboard 202, daughter board 210 may also comprise numerous other components. Processor unit 214 may be any integrated circuit capable of routing and processing packets. Preferably, processor unit 214 may be, but is not limited to, an FPGA (field programmable gate array), NPU (network processor unit), multi-core processor, multi-core packet processor, or an ASIC (application specific integrated circuit) capable of performing the deduplication described herein.

Note that in an alternative embodiment, processing unit 214 and memory 216 are part of a blade server, or part of motherboard 201, or part of a module in a network switch chip.

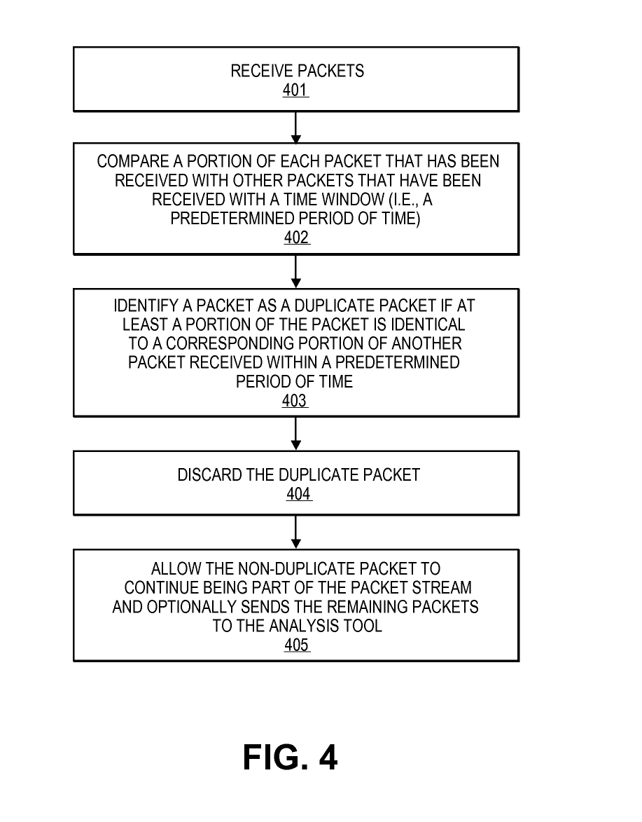

FIG. 4 is a flow diagram of one embodiment of a process for performing packet deduplication with a packet switch appliance. The process is performed by processing logic that may comprises hardware (e.g., dedicated logic, circuitry, etc.), software (such as is run on a general purpose processor or dedicated machine), or a combination of both. In one embodiment, the process is performed by processor unit 214.

Referring to FIG. 4, the process begins by processing logic receiving packets (processing block 401). In one embodiment, processor unit 214 receives the packets directly from the network packet switch 206 on motherboard 202. In another embodiment, the processor unit receives the packets indirectly from network packet switch 206 on motherboard 202 via a network packet switch on daughter board 210. The packets may have been received by network packet switch 206 from a span port of a switch in the packet switching network.

As packets are being received, processing logic compares a portion of each packet that has been received with other packets that have been received within a time window (i.e., a predetermined period of time) (e.g., a sub-second time window) (processing block 402). The size of the time window may depend on the speed of the network. In one embodiment, processing logic compares the CRC portions of an incoming packet with all other packets received within a certain window of time to determine if the incoming packet is a duplicate. In another embodiment, processing logic applies a hash or some other function to a portion of the incoming packet (e.g., the payload or portion thereof along with or without the CRC information) and compares the resulting hash value to hash values generated by applying the same function to the same portions of packets that were received within the time window. In one embodiment, the amount of the packet used for the comparisons with the hash functions is user configurable. In one embodiment, the hash function is applied to the packet payload (without the CRC information) and the result is used for the comparison.

In one embodiment, memory 216 stores a table containing copies of the portions of the previously received packets used for comparisons. Alternatively, the table may only store the values generated by applying functions (e.g., a hash function) to those portions of previously received packets that are to be compared. In one embodiment, the first packet that generates a new hash value is forwarded out from the deduplication processor automatically. Within a time window, any subsequent packets that have the same hash value are discarded. Once the time window expires, the hash value of this sequence of packets is erased and the process starts again. In one embodiment, to record when a packet is received by the de-duplication processor, a table is used that has one row for each packet and 2 columns, one for the timestamps and the second having the hash signature of the packets.

Based on the comparisons, processing logic identifies a packet as a duplicate packet if at least a portion of the packet is identical to a corresponding portion of another packet received within a predetermined period of time (processing block 403). If a packet is identified as a duplicate, then processing logic discards the packet (processing block 404).

If the packet is not identified as a duplicate, then processing logic allows the packet to continue being part of the packet stream and optionally sends the packet to the analysis tool (processing block 405). In one embodiment, processor unit 214 sends the remaining packets directly to the analysis tool. In an alternative embodiment, processor unit 214 sends the remaining packets to the analysis tool via the network switch chip 206 on the motherboard 202.

In one embodiment, processor unit 214 may also be capable of routing packets, filtering packets, slicing packets, modifying packets, copying packets, and/or flow controlling packets. Processor unit 214 may function as a packet processor. Even more preferably, processor unit 214 is an integrated circuit having programmable logic blocks and programmable interconnects that is capable of packet processing. Processor unit 214 may include firmware having instructions for packet processing functions such as deduplication, slicing, modifying, copying, and/or flow controlling packets. Processor unit 214 may process packets at line rate or at other than line rate.

Memory 216 may be any computer readable storage medium or data storage device such as RAM or ROM. In one embodiment, processor unit 214 and memory 216 may be connected. In such an embodiment, processor unit 214 may contain firmware having computer programming instructions for buffering data packets on memory 216.

Packet Flow in an Appliance with a Daughter Board Having a Processor Unit

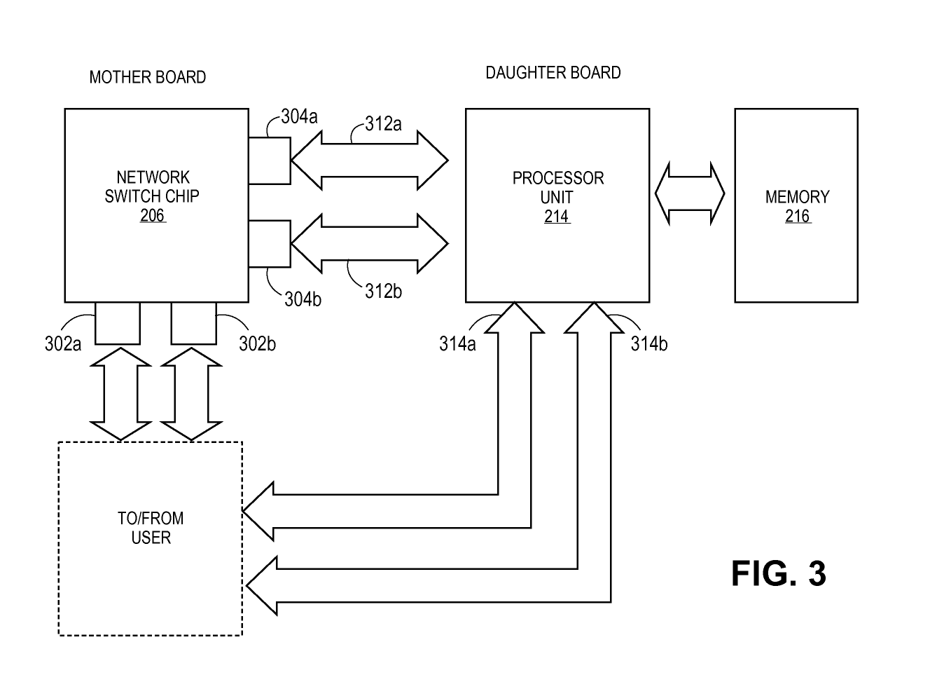

FIG. 3 logically depicts an example of packet flow in a network switch appliance 102 having a mother board removably connected to a daughter board having a processor unit.

A packet is routed from an ingress port to an egress port, both on network switch chip 206. Assume that port 302a is a network port on network switch chip 206, that port 302b is an instrument port on network switch chip 206, that ports 304a and 304b are transport ports on network switch chip 206, and that connections 312a and 312b are connections between network switch chip 206 and processor unit 214. Further assume that the packet switch appliance is configured to route all packets from network port 302a to instrument port 302b. An ingress packet received at network port 302a is routed to transport port 304a for egress by network switch chip 206. The packet is received by processor unit 214 via connection 312a. In another embodiment, the ingress packet is routed via transport port 304b and received at connection 312b. The packet is routed back to network switch chip 206 through connections 312a and transport ports 304a for egress at instrument port 302b.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A packet switching appliance for coupling to a packet switching network and one or more network devices, the appliance comprising:
a first network switch chip to receive packets from the network; and
a processor coupled to the first network switch chip and operable to perform a method comprising
receiving the packets;
identifying a packet as a duplicate packet if at least a portion of the packet is identical to a corresponding portion of another packet received within a predetermined period of time; and
discarding the packet if the packet is the duplicate packet.

2. The packet switching appliance defined in claim 1 wherein the processor identifies the packet as a duplicate packet by comparing CRC information in the packet with CRC information of the packets received within the predetermined period of time.

3. The packet switching appliance defined in claim 1 wherein the processor identifies the packet as a duplicate packet by comparing a hash value generated by applying a hash function to the portion of the packet with hash values generated from applying the hash function to corresponding portions of other packets received within the predetermined period of time.

4. The packet switching appliance defined in claim 1 wherein the processor receives the packets from the first network switch chip via a second network switch chip that is operable to forward the packets to the processor and receive packets from the processor for forwarding to the first network switch chip.

5. The packet switching appliance defined in claim 1 further comprising:
a first board that includes a processor, the first network switch chip, and a connector; and
a second board removably connected to the first board through the connector, wherein the second board includes the second network switch chip having a plurality of ports and the processor.

6. The packet switching appliance defined in claim 1 wherein the processor comprises a multicore processor, a network processor unit (NPU), an application specific integrated circuit (ASIC), or a field programmable logic gate array (FPGA).

7. The packet switching appliance defined in claim 1 wherein the packets are received by the first network switch chip from a span port of a switch or router in the network.

8. The packet switching appliance described in claim 1 wherein the packets are received from a tap in the network switch.

9. The packet switching appliance defined in claim 1 wherein the first network switch chip is operable to receive packets from the processor and forward received packets to an analysis tool.

10. A method for use by a packet switch appliance in a network, the method comprising:
receiving packets;
identifying a packet as a duplicate packet if at least a portion of the packet is identical to a corresponding portion of another packet received within a predetermined period of time; and
discarding the packet if the packet is the duplicate packet.

11. The method defined in claim 10 wherein identifying the packet as a duplicate packet comprises comparing CRC information in the packet with CRC information of the packets received within the predetermined period of time.

12. The method defined in claim 10 wherein identifying the packet as a duplicate packet comprises comparing a hash value generated by applying a hash function to the portion of the packet with hash values generated from applying the hash function to corresponding portions of other packets received within the predetermined period of time.

13. The method defined in claim 10 wherein receiving the packets occurs using a first network switch chip, and further comprising:
sending received packets from the first network switch chip to a second network switch chip;
sending the packets from the second network switch chip to a processor to identifying the packet as a duplicate packet and to discard the packet; and
sending remaining packets from the processor to the first network switch chip via the second network switch chip.

14. The method defined in claim 13 wherein the processor comprises a multicore processor, a network processor unit (NPU), an application specific integrated circuit (ASIC), or a field programmable logic gate array (FPGA).

15. The method defined in claim 14 wherein the packets are received from a span port of a switch.

16. The method defined in claim 14 where the packets are received from a tap in a network switch chip.

17. The method defined in claim 10 further comprising sending packets received from the processor via the second network switch chip to an analysis tool.

18. An article of manufacture having one or more computer readable media storing instructions thereon which, when executed by a processor, cause the processor to perform a method comprising:
receiving packets;
identifying a packet as a duplicate packet if at least a portion of the packet is identical to a corresponding portion of another packet received within a predetermined period of time; and
discarding the packet if the packet is the duplicate packet.

19. The article of manufacture defined in claim 18 wherein identifying the packet as a duplicate packet comprises comparing CRC information in the packet with CRC information of the packets received within the predetermined period of time.

20. The article of manufacture defined in claim 18 wherein identifying the packet as a duplicate packet comprises comparing a hash value generated by applying a hash function to the portion of the packet with hash values generated from applying the hash function to corresponding portions of other packets received within the predetermined period of time.
